(19) United States
(12) Patent Application Publication
(10) Pub. No.: US 2011/0058123 A1
(43) Pub. Date: Mar. 10, 2011

(54) LIGHT SOURCE DEVICE, DISPLAY DEVICE, CHASSIS AND SIDE HOLDER

(75) Inventor: Nobuhiro Kasai, Osaka-shi (JP)

(73) Assignee: SHARP KABUSHIKI KAISHA, Osaka-shi, Osaka (JP)

(21) Appl. No.: 12/990,956

(22) PCT Filed: Mar. 19, 2009
(86) PCT No.: PCT/JP2009/055436

§ 371 Date: Nov. 4, 2010

(30) Foreign Application Priority Data
May 13, 2008 (JP) 2008-125480

(51) Int. Cl. G02F 1/1335; F21V 5/00; F21V 17/06

(52) U.S. Cl. 349/62; 362/311.06; 362/433

(57) ABSTRACT

A light source device and a display device capable of preventing or minimizing occurrence of warpage, bend or distortion in a thin-plate-shaped optical member. A light source device (2) includes a chassis (11), a light source (22) that is disposed on a front side of the chassis (11), an optical member (24) having a thin plate shape that is disposed on a front side of the light source (22) and arranged to control properties of light the light source (22) emits, and a boss (114) that includes a rotation mechanism, is disposed in a protruding manner along a side of the chassis (11) that is a lower side when the thin-plate-shaped optical member (24) is in a normal usage state, and is arranged to support at least one side of the optical member (24) that is a lower side when the optical member (24) is in the normal usage state.

### TECHNICAL FIELD

The present invention relates to a light source device, a display device, a chassis and a side holder, and specifically relates to a light source device for a display device favorably used for a liquid crystal display device, a display device including the light source device, a chassis for a light source device favorably used in the present light source device, and a side holder for a light source device favorably used in the present light source device.

### BACKGROUND ART

A display device that includes a non-self-emissive display panel such as a transmissive liquid crystal display panel sometimes includes a light source device that is disposed behind the display panel. The light source device incorporated in the display device includes a light source such as a fluorescent tube, and optical members for controlling the properties of light the light source emits, and is capable of illuminating the display panel from behind with the light the properties of which are controlled. The light illuminating the display panel passes through the display panel, making an image displayed visible on a front side of the display panel.

Examples of the optical members for controlling the properties of the light that passes therethrough include an optical member having a thin plate shape, and an optical member having a sheet or film shape. The thin-plate-shaped optical member and the sheet-shaped or film-shaped optical member are disposed between the light source and the display panel, and supported by a given mechanism provided to a chassis or other components. Examples of a configuration for supporting the thin-plate-shaped optical member include a configuration such that a plurality of bosses that are disposed in a protruding manner along at least one lateral side and the lower side of the chassis support at least one lateral side and the lower side of the thin-plate-shaped optical member. It is to be noted that “lateral” and “lower” refer to the orientation of the chassis and the orientation of the optical member in a normal usage state.

With this configuration, the positions of the at least one lateral side and the lower side of the thin-plate-shaped optical member are determined by the bosses disposed in the protruding manner on the chassis or other components of the light source device. In addition, coming into contact with the bosses disposed in the protruding manner along the lower side of the chassis, the lower side of the thin-plate-shaped optical member is supported by these bosses.

It is preferable that the thin-plate-shaped optical member is supported such that deformation such as warpage, bend and distortion does not occur therein (i.e., such that the thin-plate-shaped optical member is maintained flat). If deformation such as warpage, bend and distortion occurs in the thin-plate-shaped optical member, brightness distribution in a surface direction of the light the light source emits toward the outside (i.e., toward the back side of the display panel) could be nonuniform. The nonuniform brightness distribution in the surface direction of the emitted light could produce irregular brightness or shadow on the front side (a screen) of the display panel. The irregular brightness or shadow could lower display quality of the display device. That is the reason why it is preferable that the thin-plate-shaped optical member is supported such that deformation such as warpage, bend and distortion does not occur therein.

These days, a display panel grows in size, which causes upsizing of a thin-plate-shaped optical member incorporated in a light source device. Hence, if the upsized thin-plate-shaped optical member has the above-described configuration that the lower side thereof is supported by the plurality of bosses, there could arise the following problem.

During the use of the light source device and the display device, heat liberated by the light source or the circuit board could increase the temperature inside the light source device and the display device. In accordance with the increase in temperature inside the light source device, the thin-plate-shaped optical member thermally expands. If the thin-plate-shaped optical member has the above-described configuration that the lower side thereof is supported by the plurality of bosses (i.e., a configuration such that the weight of the thin-plate-shaped optical member is put on the bosses), friction is produced between the optical member and the bosses in accordance with the weight of the optical member. The produced friction acts to hinder the thin-plate-shaped optical member from thermally expanding. The thin-plate-shaped optical member is thus hindered from thermally expanding at the sites in contact with the bosses. Consequently, the thin-plate-shaped optical member is hindered from thermally expanding while being maintained flat, which could cause warpage, bend or distortion to the thin-plate-shaped optical member.

The thin-plate-shaped optical member increases in weight because of the upsizing, so that the friction produced between the thin-plate-shaped optical member and the bosses that support the lower side of the thin-plate-shaped optical member (i.e., the bosses on which the weight of the thin-plate-shaped optical member is put) increases. Consequently, the thin-plate-shaped optical member is hindered from thermally expanding while being maintained flat, which causes warpage, bend or distortion to easily occur in the thin-plate-shaped optical member.

### CITATION LIST

### Patent Literature

PTL 1: JP2006-185908

### SUMMARY OF INVENTION

### Technical Problem

In order to overcome the problems described above, preferred embodiments of the present invention provide a light source device and a display device that are capable of preventing or minimizing occurrence of warpage, bend or distortion in a thin-plate-shaped optical member, and provide a chassis and a side holder used for the light source device. In the light source device and the display device, the thin-plate-shaped optical member is capable of changing in dimension while being maintained flat when thermally expanding. Especially when the light source device is an upsized light source device, the light source device and the display device are capable of preventing or minimizing occurrence of warpage, bend or distortion in the thin-plate-shaped optical member.

### Solution to Problem

Preferred embodiments of the present invention provide alight source device including a chassis, alight source that is disposed on a front side of the chassis, an optical member having a thin plate shape that is disposed on a front side of the light source and arranged to control properties of light the light source emits, and a boss that includes a rotation mechanism, is disposed in a protruding manner along a side of the chassis that is a lower side in a normal usage state, and is arranged to support at least a side of the optical member that is a lower side when the optical member is in the normal usage state. It is to be noted that “in a normal usage state” refers to concerning the state of the light source device or a display device when they are normally used.

It is preferable that the light source device further includes a boss that includes a rotation mechanism, is disposed on at least one lateral side of the chassis, which is lateral when the optical member is in the normal usage state, and is arranged to further support at least one lateral side of the optical member, which is lateral when the optical member is in the normal usage state.

A bearing is preferably used as the rotation mechanism.

A diffusion plate arranged to diffuse the light the light source emits is preferably used as the optical member.

In another aspect of the present invention, a display device includes the light source device described above, and a liquid crystal display panel that is disposed on a front side of the light source device.

Yet, in another aspect of the present invention, a chassis for a light source device includes a boss that includes a rotation mechanism, is disposed in a protruding manner on the chassis and is arranged to support at least a side of an optical member that is arranged to control properties of light that passes therethrough, the side being a lower side when the optical member is in a normal usage state. A bearing is preferably used as the rotation mechanism.

Yet, in another aspect of the present invention, a side holder for use on a chassis for a light source device includes a boss that includes a rotation mechanism, is disposed in a protruding manner on the side holder and is arranged to support a side of an optical member that is arranged to control properties of light that passes therethrough, the side being a lateral side when the optical member is in a normal usage state. A bearing is preferably used as the rotation mechanism.

### ADVANTAGEOUS EFFECTS OF INVENTION

According to the preferred embodiments of the present invention, the weight of the thin-plate-shaped optical member is put on the boss including the rotation mechanism. The boss including the rotation mechanism is capable of reducing friction produced between the optical member and itself, so that when the thin-plate-shaped optical member changes in dimension (e.g., when the thin-plate-shaped optical member thermally expands because of increase in temperature), the friction that acts to hinder the thin-plate-shaped optical member from changing in dimension can be reduced. Consequently, the thin-plate-shaped optical member can change in dimension while being maintained flat, which can prevent or minimize occurrence of warpage, bend or distortion in the thin-plate-shaped optical member.

If the light source device has the configuration that the boss including the rotation mechanism further supports the at least one lateral side of the optical member in the normal usage state, the friction that acts to hinder the thin-plate-shaped optical member from changing in dimension in a vertical direction can be reduced. Consequently, the thin-plate-shaped optical member can change in dimension while being maintained flat, which can prevent or minimize occurrence of warpage, bend or distortion in the thin-plate-shaped optical member.

If the bearing is used as the rotation mechanism, the friction produced between the thin-plate-shaped optical member and the boss can be reduced with ease at a low cost.

### BRIEF DESCRIPTION OF DRAWINGS

FIG. 1 is an external perspective view showing a schematic configuration of a chassis that is used in a light source device according to a preferred embodiment of the present invention.

FIG. 2 is an external perspective view showing a schematic configuration of a side holder that is used in the light source device according to the preferred embodiment of the present invention.

FIG. 3 is an exploded perspective view showing a schematic configuration of the light source device according to the preferred embodiment of the present invention.

FIG. 4 is an exploded perspective view showing a schematic configuration of a display device that includes the light source device according to the preferred embodiment of the present invention (i.e., a display device according to another preferred embodiment of the present invention).

FIG. 5 is an exploded perspective view showing a schematic configuration of a television receiver that includes the display device according to the preferred embodiment of the present invention.

### DESCRIPTION OF EMBODIMENTS

A detailed description of preferred embodiments of the present invention will now be provided with reference to the accompanying drawings.

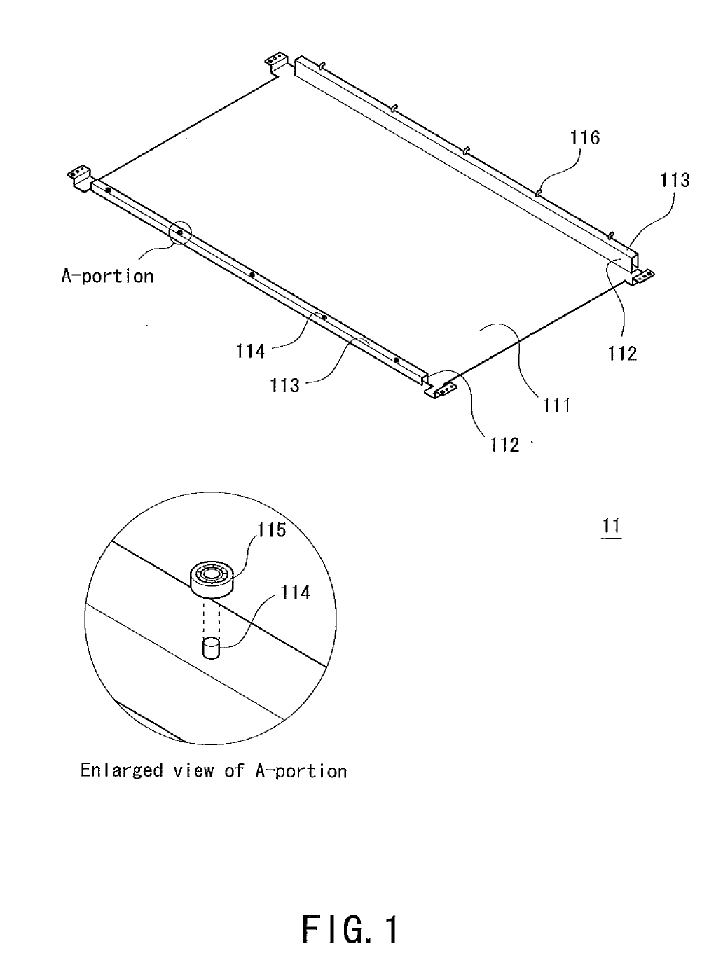

FIG. 1 is an external perspective view showing a schematic configuration of a chassis 11 for a light source device according to one of the preferred embodiments of the present invention. The chassis 11 has the shape of a substantially square tray of low height. One of the longer sides of the four sides of the chassis 11 is defined as an upper side in a normal usage state, and the other longer side is defined as a lower side in a normal usage state. The shorter sides of the chassis 11 are defined as lateral sides in a normal usage state. It is to be noted that “in a normal usage state” refers to concerning the state of the light source device or a display device when they are normally used. In FIG. 1, the front side of the chassis 11 faces toward the top of FIG. 1, and the back side faces toward the bottom of FIG. 1.

As shown in FIG. 1, the chassis 11 includes a bottom 111 having a substantially planar surface, and side walls 112 disposed along the longer sides of the bottom 111. The side walls 112 are formed by bending to raise the longer sides of the chassis 11 toward the front side of the chassis 11. Support faces 113 that are substantially parallel to the bottom 111 are provided at the top ends of the side walls 112. The support faces 113 have a configuration such that the longer sides of an optical member having a thin plate shape are to be placed thereon.

A plurality of bosses 114 each including rotation mechanisms are disposed in a manner protruding toward the front side on the support face 113 that is to be located on the lower side in the normal usage state. For example, as shown in FIG. 1, the plurality of bosses 114 including the rotation mechanisms are disposed at regular intervals in a direction of the longer sides. The plurality of bosses 114 and the support face 113 may be manufactured to have a monolithic construction by subjecting the support face 113 to press working. Alternatively, the plurality of bosses 114 and the support face 113 may be manufactured to have a separate construction, which are put together later. It is essential only that the plurality of bosses 114 should be disposed in the protruding manner toward the front side on the support face that is to be located on the lower side in the normal usage state.

A bearing 115 is attached around the perimeter of each boss 114. A variety of conventional radial bearings can be used for the bearings 115. The bosses 114 disposed in the protruding manner on the support face 113 that is to be located on the lower side in the normal usage state thus include the rotation mechanisms. In other words, the perimeter of each boss 114 is rotatable.

Having the configuration described above, the bosses 114 disposed in the protruding manner on the support face 113 located on the lower side support the lower side of the thin-plate-shaped optical member when the light source device (the chassis 11 thereof) is brought into the normal usage state. To be specific, the outer surfaces of the bearings 115 attached around the perimeters of the bosses 114 are in contact with the lower side of the thin-plate-shaped optical member. The bearings 115 have a low rotational resistance, so that friction produced between the thin-plate-shaped optical member and the bosses 114 including the rotation mechanisms is reduced.

Thus, even when the thin-plate-shaped optical member thermally expands because of increase in temperature, the bosses 114 including the rotation mechanisms do not hinder the thin-plate-shaped optical member from changing in dimension. Consequently, the thin-plate-shaped optical member can change in dimension in a horizontal direction (in the normal usage state) with ease, which can prevent occurrence of warpage, bend or distortion in the thin-plate-shaped optical member.

A plurality of hooks 116 are disposed in a manner protruding toward the front side on the support face 113 that is to be located on the upper side in the normal usage state. The hooks 116 are used to hook thereon an optical member having a sheet or film shape to be described later. The shape, the dimension and the number of the hooks 116 are not limited specifically. The hooks 116 suffice if they have a configuration such that the sheet-shaped or film-shaped optical member can be hooked thereon.

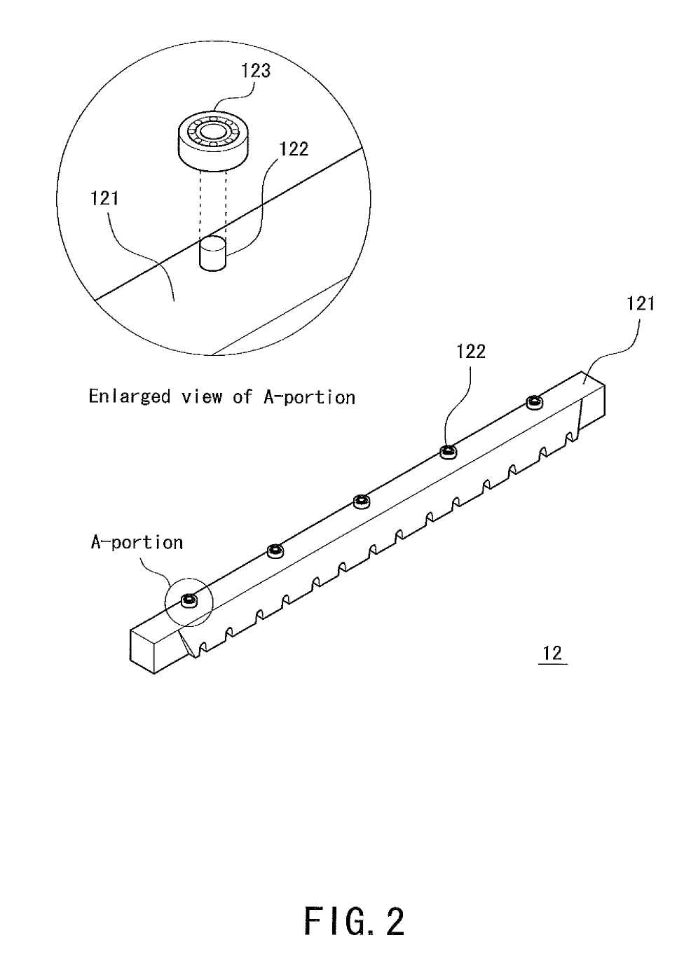

FIG. 2 is an external perspective view showing a schematic configuration of a side holder 12 for a light source device according to one of the preferred embodiments of the present invention. As shown in FIG. 2, the side holder 12 has the shape of a substantial bar. The side holder 12 is preferably made from a resin material so as to have a monolithic construction. Used in pair, the side holders 12 are arranged to cover both end portions (electrode portions) of light sources to be described later, and function as spacers on which the thin-plate-shaped optical sheet is to be placed. In FIG. 2, the front side of the side holder 12 faces toward the top of FIG. 2.

As shown in FIG. 2, a support face 121 on which the thin-plate-shaped optical sheet is to be placed is provided on the front side of the side holder 12. A plurality of bosses 122 each including rotation mechanisms are disposed in a manner protruding toward the front side on the support face 121. To be specific, as shown in FIG. 2, the plurality of bosses 122 including the rotation mechanisms are disposed at regular intervals along a longitudinal direction of the side holder 12. The side holder 12 may be manufactured such that the bosses 122 and the side holder 12 have a monolithic construction. Alternatively, the bosses 122 and the side holder 12 may be manufactured to have a separate construction, which are put together later. The plurality of bosses 122 suffice if they are disposed in the protruding manner toward the front side on the support face 121.

A bearing 123 is attached around the perimeter of each boss 122. A variety of conventional radial bearings can be used for the bearings 123. Thus, the bosses 122 disposed in the protruding manner on the support face 121 that is to be located on the lateral side in the normal usage state include the rotation mechanisms. In other words, the perimeter of each boss 122 is rotatable.

Having the configuration described above, the side holders 12 are located at the lateral sides when the light source device is brought into the normal usage state. The bosses 122 including the rotation mechanisms and disposed in the protruding manner on the side holders 12 are arranged to determine the positions of the lateral sides of the thin-plate-shaped optical member. To be specific, the outer surfaces of the bearings 123 attached around the perimeters of the bosses 122 are in contact with the lateral sides of the thin-plate-shaped optical member. The bearings 123 have a low rotational resistance, so that friction produced between the thin-plate-shaped optical member and the bosses 122 including the rotation mechanisms is reduced.

Thus, even when the thin-plate-shaped optical member thermally expands because of increase in temperature, the bosses 122 including the rotation mechanisms do not hinder the thin-plate-shaped optical member from changing in dimension. Consequently, the thin-plate-shaped optical member can change in dimension in the vertical direction (in the normal usage state) with ease, which can prevent occurrence of warpage, bend or distortion in the thin-plate-shaped optical member.

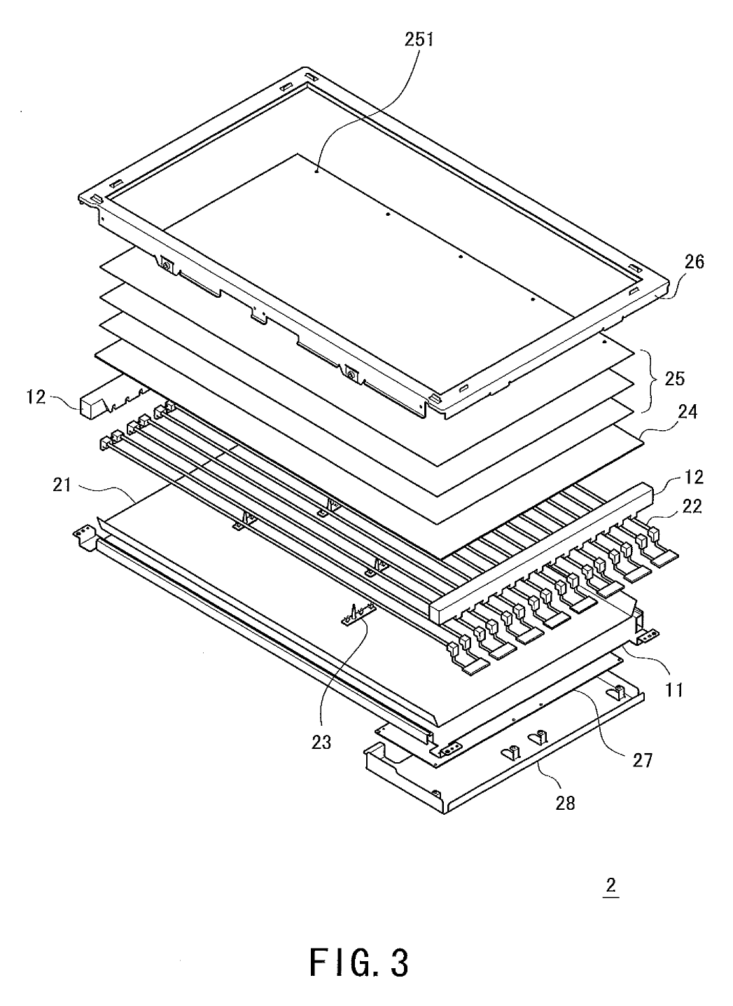

Next, a description of the light source device that includes the chassis 11 and the side holders 12 according to the preferred embodiments of the present invention will be provided. FIG. 3 is an exploded perspective view showing a schematic configuration of a light source device 2 that includes the chassis 11 and the side holders 12 according to the preferred embodiments of the present invention (i.e., the light source device 2 according to one of the preferred embodiments of the present invention). In FIG. 3, the front side of the light source device 2 according to the preferred embodiment of the present invention faces toward the top of FIG. 3, and the back side faces toward the bottom of FIG. 3.

The light source device 2 according to the preferred embodiment of the present invention includes the chassis 11 according to the preferred embodiment of the present invention, a reflection sheet 21, light sources 22, lamp clips 23, the side holders 12 according to the preferred embodiment of the present invention, an optical member 24 having a thin plate shape, an optical member 25 having a sheet or film shape, a frame 26, a light source driving circuit board 27, and alight source driving circuit board cover 28. The configurations of the chassis 11 and the side holders 12 according to the preferred embodiments of the present invention are as described above.

The reflection sheet 21 has a sheet or film shape or a plate shape, and has the surface property of diffusely reflecting light. The reflection sheet 21 is preferably made from expanded PET (polyethylene terephthalate).

The light sources 22 are capable of emitting light with a given wavelength. A variety of conventional light sources can be used for the light sources 22. Examples of the conventional light sources include a fluorescent tube such as a cold cathode fluorescent tube and a hot cathode fluorescent tube, a discharge lamp such as a xenon lamp, and a light emitting element such as an LED (Light Emitting Diode). The light source device 2 shown in FIG. 3 has a configuration of including linear fluorescent tubes as the light sources 22; however, the present invention is not limited to this configuration.

The lamp clips 23 are arranged to hold the light sources 22 to fix to the chassis 11, and function as spacers for providing space between the thin-plate-shaped optical member 24 and the light sources 22. Each lamp clip 23 is preferably made from a resin material so as to have a monolithic construction.

A diffusion plate is preferably used as the thin-plate-shaped optical member 24. The diffusion plate is arranged to randomly diffuse light that passes therethrough, allowing uniformalization of brightness distribution in a surface direction of the light the light sources 22 emit. The diffusion plate is made from a nearly clear resin material that is a base material, in which fine particles having the property of reflecting light are mixed. The diffusion plate has a thing plate shape by being subjected to injection molding, for example.

A diffusion sheet, a lens sheet and a reflective polarizing sheet are preferably used for the sheet-shaped or film-shaped optical member 25. Engaging holes 251 in which the hooks 116 disposed in the protruding manner on the chassis 11 are to be engaged are disposed along one longer side (the upper side in the normal usage state) of the sheet-shaped or film-shaped optical member 25. The number, the dimension and the shape of the engaging holes 251 are determined in accordance with those of the hooks 116 disposed in the protruding manner on the chassis 11. The sheet-shaped or film-shaped optical member 25 suffices if it has a configuration of being hooked on the hooks 116.

The diffusion sheet is arranged to randomly diffuse light that passes therethrough, allowing uniformalization of brightness distribution in the surface direction of the light. The diffusion plate is made from a nearly clear material that is a base material, in which fine particles having the property of reflecting light are mixed, and is formed into a sheet or film shape. The nearly clear base material is preferably PET (polyethylene terephthalate).

The lens sheet has a layer structure made up of a base layer, and a layer of a given cross-sectional shape that has a light-gathering function. The base layer is preferably made from PET (polyethylene terephthalate). The layer having the light-gathering function is preferably made from an acrylic resin. The lens sheet has the function of enhancing, by gathering the light that passes therethrough, brightness of the light.

The reflective polarizing sheet (also referred to as a brightness enhancement sheet) is arranged to transmit light that is polarized in a given direction (i.e., light that vibrates in a given direction), and reflect light other than the polarized light. The reflective polarizing sheet is preferably a DBEF film (DBEF is a registered trademark of 3M COMPANY).

The frame 26 has the function of supporting and/or protecting a display panel, which is described later. As shown in FIG. 3, the frame 26 has a substantially square shape with an opening. The frame 26 may have a monolithic construction of a synthetic resin material, may be made up of separate parts made from a synthetic resin material, may be made of a metal plate subjected to press working, or may be made up of separate parts preferably made of metal plates.

The light source driving circuit board 27 incorporates electronic circuits and/or electric circuits for driving the light sources 22. When fluorescent tubes are used for the light sources 22, the light source driving circuit board 27 incorporates inverter circuits. The light source driving circuit board cover 28 has the shape of a plate, or a tray of low height to cover the light source driving circuit board 27. The light source driving circuit board cover 28 is arranged to protect the light source driving circuit board 27, and prevent unnecessary radiation from the light source driving circuit board 27. For this purpose, the light source driving circuit board cover 28 is made from a conductor such as metal.

Next, a description of assembly of the light source device 2 including these components will be provided.

The description is provided with reference to FIG. 3. The reflection sheet 21 is laid on the front side of the bottom 111 of the chassis 11. The light sources 22 are arranged in parallel on the front side of the reflection sheet 21. The light sources 22 are held by the lamp clips 23 and fixed to the front side of the bottom 111 of the chassis 11.

The side holders 12 are disposed along the shorter sides of the chassis 11 so as to cover both the end portions (electrode portions) of the light sources 22.

The thin-plate-shaped optical member (diffusion plate in the preferred embodiment of the present invention) 24 is disposed in a region surrounded by the bosses 114 including the rotation mechanisms and disposed in the protruding manner on the chassis 11, the hooks 116 disposed in the protruding manner on the chassis 11, and the bosses 122 including the rotation mechanisms and disposed in the protruding manner on the side holders 12. In this configuration, when the light source device 2 is brought into the normal usage state, the longer side where the bosses 114 including the rotation mechanisms are disposed in the protruding manner becomes the lower side while the longer side where the hooks 116 are disposed in the protruding manner becomes the upper side. In addition, the shorter sides where the side holders 12 are disposed become the lateral sides. Thus, the lower side of the thin-plate-shaped optical member (diffusion plate) 24 is supported by the bosses 114 including the rotation mechanisms and disposed in the protruding manner along the lower side of the chassis 11. In addition, the positions of the lateral sides of the thin-plate-shaped optical member (diffusion plate) 24 are determined by the bosses 122 including the rotation mechanisms and disposed in the protruding manner on the side holders 12.

With the configuration described above, the bosses 114 and the bosses 122 including the rotation mechanisms are rotatable, and thus capable of reducing friction produced between the thin-plate-shaped optical member (diffusion plate) 24 and themselves. To be specific, when the thin-plate-shaped optical member (diffusion plate) 24 thermally expands (changes in dimension) because of increase in temperature, the friction applied thereto is not large because the bosses 114 and the bosses 122 that are in contact with the lower side and the lateral sides of the thin-plate-shaped optical member (diffusion plate) 24 rotate. Thus, the thin-plate-shaped optical member (diffusion plate) 24 can change in dimension without hindrance. Even when the thin-plate-shaped optical member (diffusion plate) 24 changes in dimension, occurrence of warpage, bend or distortion in the thin-plate-shaped optical member (diffusion plate) 24 is prevented or minimized.

The sheet-shaped or film-shaped optical member 25 is laid on the front side of the thin-plate-shaped optical member (diffusion plate) 24. The hooks 116 disposed in the protruding manner on the chassis 11 are engaged in the engaging holes 251 disposed along the one longer side of the sheet-shaped or film-shaped optical member 25. Thus, the sheet-shaped or film-shaped optical member 25 is hooked on the hooks 116 disposed in the protruding manner on the chassis 11.

Specific combinations of the thin-plate-shaped optical member 24 and the sheet-shaped or film-shaped optical member 25 include (1) a combination of a diffusion plate that is used as the thin-plate-shaped optical member 24, and a diffusion sheet, a lens sheet and a reflective polarizing sheet that are used for the sheet-shaped or film-shaped optical member 25, where the diffusion plate, the diffusion sheet, the lens sheet and the reflective polarizing sheet are layered in this order from the back side of the light source device 2, (2) a combination of a diffusion plate that is used as the thin-plate-shaped optical member 24, and a reflective polarizing sheet and two diffusion sheets that are used for the sheet-shaped or film-shaped optical member 25, where the diffusion plate, the two diffusion sheets and the reflective polarizing sheet are layered in this order from the back side of the light source device 2, (3) a combination of a diffusion plate that is used as the thin-plate-shaped optical member 24, and a lens sheet and two diffusion sheets that are used for the sheet-shaped or film-shaped optical member 25, where the diffusion plate, the first diffusion sheet, the lens sheet and the second diffusion sheet are layered in this order from the back side of the light source device 2, and (4) a combination of a diffusion plate that is used as he thin-plate-shaped optical member 24, and one, two or three diffusion sheets that are used for the sheet-shaped or film-shaped optical member 25, where the diffusion plate, the predetermined number of diffusion sheets (one, two or three) are layered in this order from the back side of the light source device 2.

The combinations of the thin-plate-shaped optical member (diffusion plate) 24 and the sheet-shaped or film-shaped optical member 25 are not limited to the ones described above. The combination is preferably determined according to the kinds of the light source device 2 and the display device.

Then, the frame 26 is attached to the front side of the chassis 11. The light source driving circuit board 27 is disposed on the back side of the chassis 11. The light source driving circuit board cover 28 is disposed so as to cover the light source driving circuit board 27.

With the configuration described above, when the light source device 2 is brought into the normal usage state, the lower side of the thin-plate-shaped optical member (diffusion plate) 24 is supported by the bosses 114 (including the rotation mechanisms) disposed in the protruding manner on the chassis 11. Because the bosses 114 including the rotation mechanisms rotate, friction produced at the sites in contact with the thin-plate-shaped optical member (diffusion plate) 24 can be reduced. Thus, even when the thin-plate-shaped optical member (diffusion plate) 24 thermally expands because of increase in temperature, the bosses 114 including the rotation mechanisms do not hinder the thin-plate-shaped optical member (diffusion plate) 24 from changing in dimension. Consequently, the thin-plate-shaped optical member can change in dimension in the horizontal direction with ease, which can prevent or minimize occurrence of warpage, bend or distortion in the thin-plate-shaped optical member (diffusion plate) 24.

In addition, when thermally expanding, the thin-plate-shaped optical member (diffusion plate) 24 is sometimes pressed at its lateral sides against the bosses 122 of the side holders 12 that include the rotation mechanisms. The bosses 122 including the rotation mechanisms can reduce friction produced at the sites in contact with the thin-plate-shaped optical member (diffusion plate) 24, and accordingly do not hinder the thin-plate-shaped optical member (diffusion plate) 24 from changing in dimension in the vertical direction even when the thin-plate-shaped optical member (diffusion plate) 24 thermally expands to be pressed against the bosses 122 including the rotation mechanisms. Consequently, the thin-plate-shaped optical member (diffusion plate) 24 can change in dimension in the vertical direction with ease, which can prevent occurrence of warpage, bend or distortion in the thin-plate-shaped optical member (diffusion plate) 24.

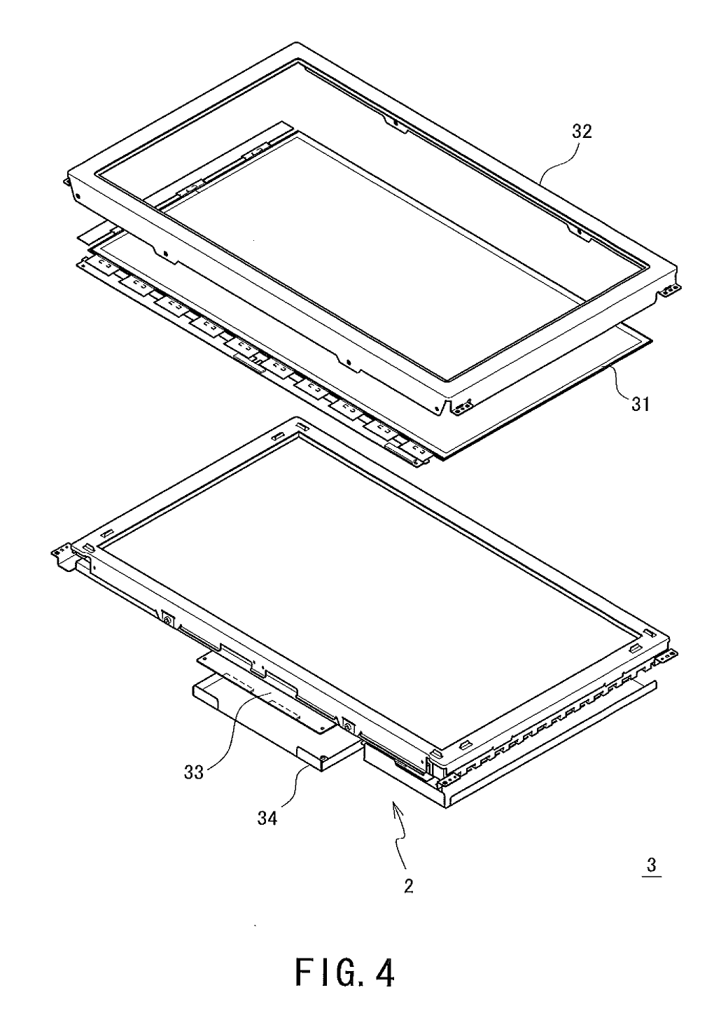

Next, a description of a display device 3 that includes the light source device 2 according to the preferred embodiment of the present invention (i.e., the display device 3 according to one of the preferred embodiments of the present invention) will be provided. FIG. 4 is an exploded perspective view showing a schematic configuration of the display device 3 according to the preferred embodiment of the present invention.

As shown in FIG. 4, the display device 3 according to the preferred embodiment of the present invention includes the light source device 2 according to the preferred embodiment of the present invention, a display panel 31, a bezel 32, a control circuit board 33, and a control circuit board cover 34.

A variety of conventional transmissive display panels can be used for the display panel 31. For example, a generally-used transmissive active matrix liquid crystal display panel can be used. The bezel 32 has the function of supporting and/or protecting the display panel 31. As shown in FIG. 4, the bezel 32 has a substantially square shape with an opening. The control circuit board 33 incorporates electronic circuits and/or electric circuits for generating a control signal to drive the display panel 31 based on a signal inputted from the outside (e.g., a tuner). The control circuit board cover 34 has the shape of a plate, or a tray of low height to cover the control circuit board 33. The control circuit board cover 34 is arranged to protect the control circuit board 33, and prevent unnecessary radiation from the control circuit board 33.

Next, a description of assembly of the display device 3 according to the preferred embodiment of the present invention will be provided. The display panel 31 is disposed on the front side of the frame 26 of the light source device 2 according to the preferred embodiment of the present invention. Then, the bezel 32 is attached to the front side of the display panel 31. Thus, the display panel 31 is interposed between the frame 26 of the light source device 2 according to the preferred embodiment of the present invention and the bezel 32. The control circuit board 33 is disposed on the back side of the chassis 11 of the light source device 2 according to the preferred embodiment of the present invention. The control circuit board cover 34 is disposed so as to cover the control circuit board 33.

In the display device 3 having the configuration described above, the light emitted from the light source device 2 according to the preferred embodiment of the present invention passes through the display panel 31 and makes an image displayed visible on the front side of the display panel 31. As described above, occurrence of warpage, bend or distortion in the thin-plate-shaped optical member (diffusion plate) 24 is prevented or minimized even when the thin-plate-shaped optical member (diffusion plate) 24 changes in dimension. Consequently, the display device 3 according to the preferred embodiment of the present invention can achieve high-definition image display without irregular brightness or shadow.

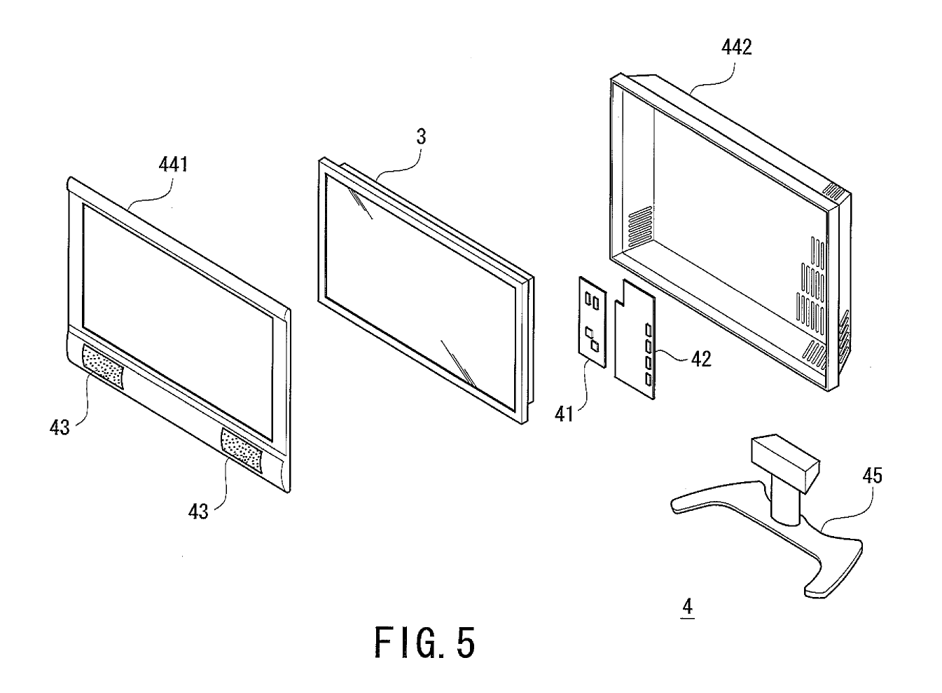

Next, a brief description of a television receiver 4 including the display device 3 according to the preferred embodiment of the present invention will be provided. FIG. 5 is an exploded perspective view showing a schematic configuration of the television receiver 4 including the display device 3 according to the preferred embodiment of the present invention. As shown in FIG. 5, the television receiver 4 includes the display device 3 according to the preferred embodiment of the present invention, an electric power supply 41, a tuner 42, loudspeaker units 43, a cabinet 441, 442, and a supporting member 45.

The electric power supply 41 is arranged to supply electric power to the display device 3 according to the preferred embodiment of the present invention, the tuner 42 and other components.

The tuner 42 is arranged to produce an image signal and a sound signal of a given channel based on a received radio wave and a signal inputted from the outside. A conventional terrestrial tuner (analog, digital, or both), a BS tuner and a CS tuner may be used for the tuner 42.

The display device 3 according to the preferred embodiment of the present invention is arranged to display an image based on the image signal of the given channel produced by the tuner 42. The loudspeaker units 43 are arranged to produce a sound based on the sound signal produced by the tuner 42. A variety of conventional loudspeaker units such as generally-used speakers may be used for the loudspeaker units 43.

The display device 3 according to the preferred embodiment of the present invention, the electric power supply 41, the tuner 42 and the loudspeaker units 43 are housed in the cabinet (the cabinet in FIG. 5 consists of the front side cabinet 441 and the back side cabinet 442), which is supported by the supporting member 45. The television receiver 4 is not limited to this configuration. For example, the electric power supply 41, the tuner 42 and the loudspeaker units 43 may be mounted on the display device 3 according to the preferred embodiment of the present invention.

The foregoing descriptions of the preferred embodiments of the present invention have been presented for purposes of illustration and description with reference to the drawings. However, it is not intended to limit the present invention to the preferred embodiments, and modifications and variations are possible as long as they do not deviate from the principles of the present invention.

1. A light source device that comprises:
a chassis;
a light source that is disposed on a front side of the chassis;
an optical member having a thin plate shape that is disposed on a front side of the light source, and arranged to control properties of light the light source emits; and
a boss that comprises a rotation mechanism, is disposed in a protruding manner along a side of the chassis that is a lower side when the thin-plate-shaped optical member is in a normal usage state, and is arranged to support at least one side of the optical member that is a lower side when the optical member is in the normal usage state.

2. The light source device according to claim 1, wherein the rotation mechanism comprises a bearing.

3. The light source device according to claim 1, wherein the optical member comprises a diffusion plate arranged to diffuse the light the light source emits.

4. A display device that comprises:
the light source device according to claim 1; and
a liquid crystal display panel that is disposed on a front side of the light source device.

5. A chassis for a light source device that comprises:
a boss that comprises a rotation mechanism, is disposed in a protruding manner on the chassis, and is arranged to support at least one side of an optical member that is arranged to control properties of light that passes therethrough, the side being a lower side when the optical member is in a normal usage state.

6. The chassis according to claim 5, wherein the rotation mechanism comprises a bearing.

7. A side holder for use on a chassis for a light source device, the side holder comprising:
a boss that comprises a rotation mechanism, is disposed in a protruding manner on the side holder, and is arranged to support a side of an optical member that is arranged to control properties of light that passes therethrough, the side being a lateral side when the optical member is in a normal usage state.

8. The chassis according to claim 7, wherein the rotation mechanism comprises a bearing.
